(19) United States
(12) Patent Application Publication
(10) Pub. No.: US 2012/0256080 A9
(43) Pub. Date: Oct. 11, 2012

(54) SELECTIVELY TRANSLUCENT WINDOW

(75) Inventor: Daniel C. Mikat, Milford, MI (US)

(73) Assignee: Toyota Motor Engineering & Manufacturing North America, Inc., Erlanger, KY (US)

(21) Appl. No.: 12/777,071

(22) Filed: May 10, 2010

(51) Int. Cl. G01J 1/44

(52) U.S. Cl. 250/214 R

(57) ABSTRACT

A system and method for controlling the intensity of light into a cabin space is provided. The system includes a controller in communication with a window. The window is configured to have variable transmittance. The system further includes a sensor operable to detect the state of a pupil. The sensor is also in communication with the controller. The controller processes the state of an iris of a user so as to adjust the transmissivity of the window. Accordingly, the intensity of light entering into a cabin space may be controlled so as to facilitate the vision of the occupants.

### FIELD OF THE INVENTION

The invention relates to a system and method for adjusting the intensity of light entering a cabin space. More specifically, the invention relates to a system having a controller, a window with variable transmittance, and a sensor operable to detect the state of a pupil. The window and the sensor are both in communication with the controller. The controller processes the state of the pupil of an occupant so as to adjust the transmissivity of the window. Accordingly, the system and method automatically changes the intensity of light entering into a cabin space so as to establish a calculated condition of ambient light within the cabin space operable to prevent the occupant's vision from being impaired.

### BACKGROUND OF THE INVENTION

Platforms such as vehicles have windows from which occupants may view the environment. However, during certain operating conditions the ambient light may be such that the occupant's vision is impaired. Accordingly, manual devices such as sunglasses or shades and screens may be used to reduce the intensity of light. However, in some cases the occupant may not have sunglasses available or may be preoccupied with operating the vehicle. Accordingly, it remains desirable to have a system that automatically adjusts the transmissivity of a window so as to allow a predetermined intensity of light to enter into a cabin space.

### SUMMARY OF THE INVENTION

According to one aspect of the invention, a system for controlling the intensity of light entering a cabin space is provided. The system includes a controller in communication with a window. The window is configured to have variable transmittance. The system further includes a sensor operable to detect the state of a pupil. The sensor is also in communication with the controller. The controller processes the state of the pupil of a user so as to calculate a condition of ambient lighting within the cabin space configured to facilitate the operation of the eye. The controller is further operable to adjust the transmissivity of the window so as to generate a transmissivity configured to establish the calculated condition of ambient lighting within the cabin space. Accordingly, the intensity of light entering into a cabin space may be controlled so as to facilitate the vision of the occupants. According to another embodiment of the invention, a method for controlling the intensity of light entering a cabin space is also provided. The method includes the steps of providing a window having variable transmittance and detecting the state of a pupil and adjusting the transmissivity of the window based upon the state of the pupil.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of the operation of the system of the present invention;

FIG. 2 is a view of the cabin space showing a state of an iris corresponding to maximum transmissivity of the window;

FIG. 3 shows a state of an iris wherein the transmissivity of the window is reduced;

FIG. 4 is a view of the cabin space of a vehicle showing the state of an iris corresponding to maximum reduction of transmissivity of a window;

FIG. 5 is a view of a second preferred embodiment of the present invention showing a plurality of sensors each operable to adjust the transmissivity of a designated area of the vehicle;

FIG. 6 is a diagram showing the steps of a method of the present invention; and

FIG. 7 is a diagram showing the steps of a method of the present invention having automatic tuning features.

### DETAILED DESCRIPTION OF THE INVENTION

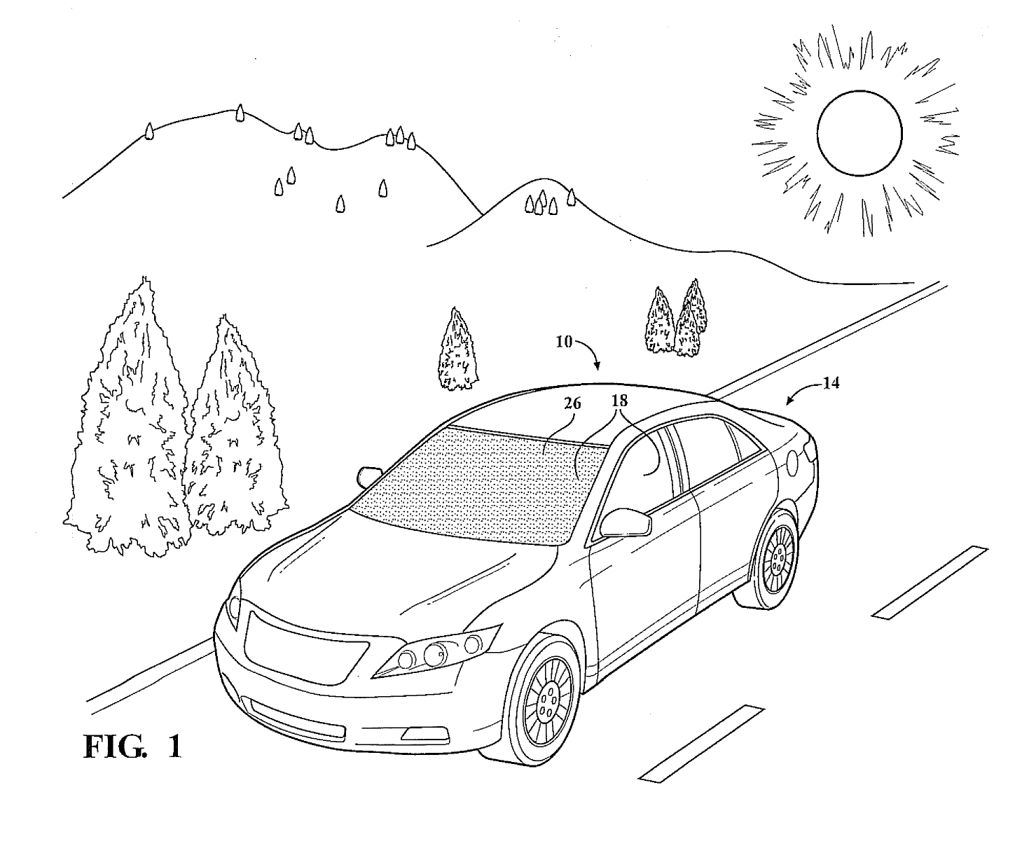

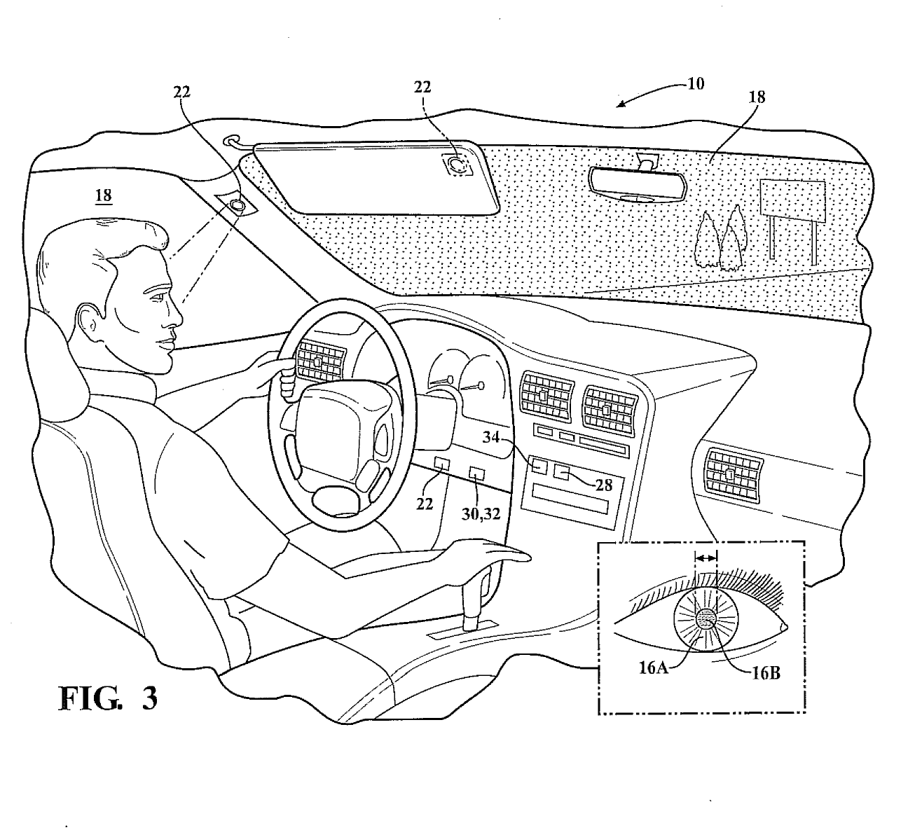

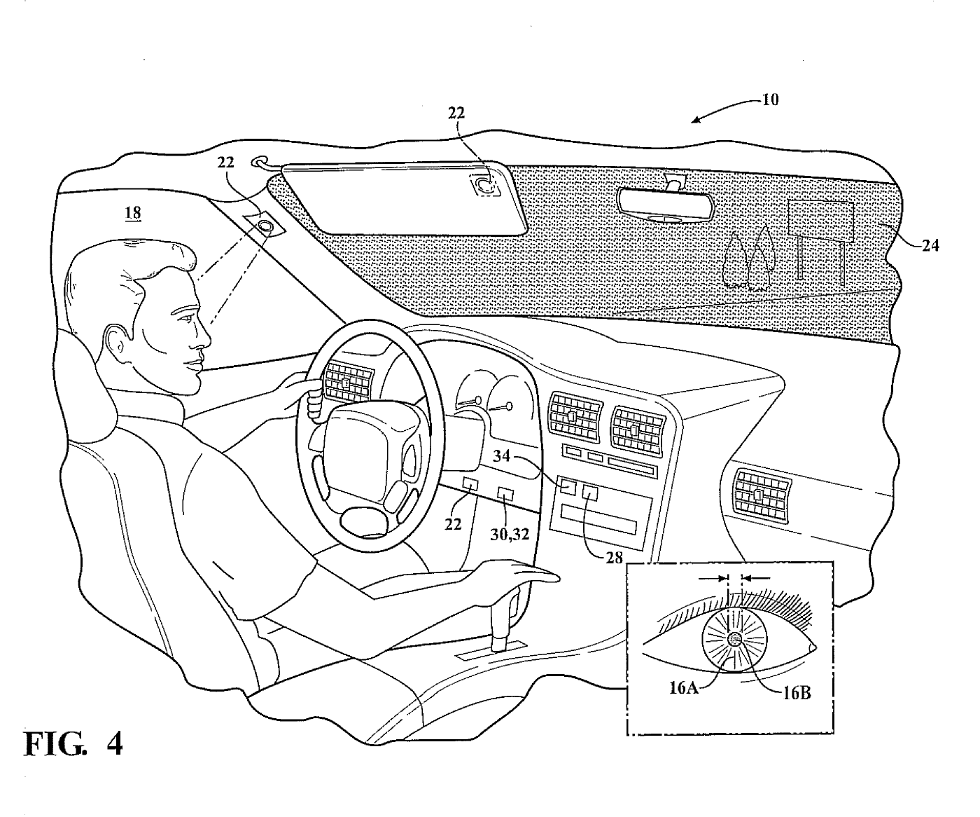

Referring to FIGS. 1-4, a system 10 for controlling the intensity of light entering a cabin space 12 is provided. The system 10 may be implemented in a platform 14 such as the vehicle shown in the figures. However, it is understood by those skilled in the art that the system 10 may be integrated into other platforms 14 such as aircraft, commercial buses, or the like. The system 10 detects the intensity of ambient light within the cabin space 12 as indicated by the state of an open pupil 16 and changes the transmissivity of a window 18 so as to prevent the light from interfering with the passengers' vision.

The system 10 includes a controller 20 such as a computer processing unit (CPU) or the platform's 14 engine control unit (ECU). The system 10 further includes windows 18 having variable transmittance. The window 18 is in communication with the controller 20 and the controller 20 is operable to change the transmissivity of the window 18.

The system 10 also includes a sensor 22 operable to detect the state of an iris 16a. The sensor 22 is also in communication with the controller 20. The controller 20 processes the state of the iris 16a of the user so as to adjust the transmissivity of the window 18. More specifically, the sensor 22 may be operable to detect the state of the iris 16a so as to determine diameter of the pupil 16b. The diameter of the pupil 16b is controlled by muscles in the iris 16a. The muscles of the iris 16a form an opening and the opening expands and contracts based upon the amount of ambient light detected. The pupil 16b is visible though the opening. As used herein, the diameter of the pupil 16b refers to the diameter of the pupil 16b as seen through the opening of iris 16a. The controller 20 processes the state of the iris 16a of a user so as to calculate a condition of ambient lighting within the cabin space 12 configured to facilitate the operation of the eye. The controller 20 is further operable to adjust the transmissivity of the window 18 so as to generate a transmissivity configured to establish the calculated condition of ambient lighting within the cabin space 12.

The system 10 uses the diameter of the pupil 16b to adjust the transmissivity of the window 18. Generally speaking, the opening of the iris 16a dilates and constricts based upon the intensity of light detected. For instance, it is known that the diameter of the pupil 16b is largest when the eye receives very little light, such as at night. However, the diameter of the pupil 16b constricts as the intensity of light increases. Accordingly, the sensor 22 is operable to detect the diameter of the pupil 16b and actuate the window 18 so as to adjust the transmissivity of the window 18. Further, the diameter of the pupil 16b can range between three and nine millimeters based upon the amount of light detected. A relationship between the ambient light and pupil 16b diameter may be used to adjust the transmissivity of the window 18 so as to maximize comfort of the passengers.

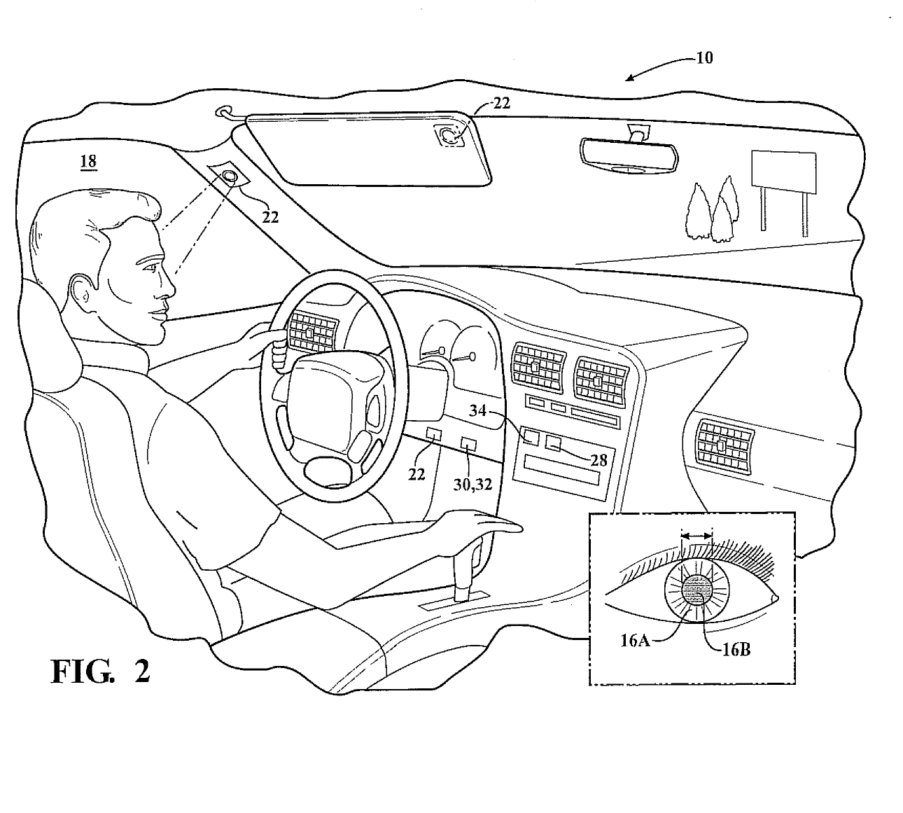

With reference now to FIG. 2, the sensor 22 is shown mounted within the cabin space 12 of a vehicle. The sensor 22 may be mounted onto the A pillar adjacent the roof or alternatively may be mounted onto the surface of a sun visor. The sensor 22 is directed to detect a space within the cabin in which the passenger's eye may be found. The sensor 22 may be hardwired to the controller 20, or in wireless communication with the controller 20.

The window 18 may also be hardwired to the controller 20. The controller 20 processes the state of the eye so as to adjust the transmissivity of the window 18 as the state of the eye changes with respect to the intensity of light entering into the cabin space 12. Transmissivity as used herein refers to the amount of electromagnetic energy able to pass through the window 18, specifically the amount of light passed through the window 18. Windows 18 having variable transmittance are known and may include windows 18 impregnated with liquid crystal cells 24, or having a layer of electrochromic material 26, or what is commonly referred to in the art as suspended particle devices. Any one of such windows 18 are suitable for use herein and are generally operable to change transmissivity based upon the amount of electric current run through the window 18.

Generally speaking, electric current may be run through the window 18 so as to change the transmissivity of the window 18. For instance, an electric current applied to a window 18 having liquid crystal cells 24 changes the positional relationship of the liquid crystal cells 24 with respect to each other, which in turn adjusts the transmissivity of the window 18. With respect to electrochromic materials 26, electrochromic material 26 becomes darker with the amount of electricity passed through the material. Accordingly, the system 10 determines the diameter of the pupil 16b, and adjusts the amount of electric current running through the window 18 so as to change the transmissivity of the window 18 to create a desired condition of ambient light within the cabin space 12.

The system 10 may further include an input 28 and database 30. The input 28 and the database 30 are both in communication with the controller 20. The input 28 may be actuated by a user to transmit user information into the database 30. The input 28 may be further operable to transmit user information to the controller 20. The database 30 is operable to store sensor 22 information. The controller 20 is further operable to process user information and sensor information so as to calculate a transmissivity profile 32 for each of the plurality of users.

The transmissivity profile 32 establishes a transmissivity relationship of the window 18 commensurate with the diameter of the pupil 16b of a particular user. Generally speaking, the average diameter of a pupil 16b in a complete wide open state is nine millimeters, wherein ambient light is nearly undetectable. Conversely, the average diameter is operable to constrict to three diameters in conditions of intense light. Further, the diameter may be affected with age. The transmissivity profile 32 is tuned to the actual diameter of the pupil 16b of a user with respect to the ambient light detected by the particular user.

The controller 20 may include a baseline diameter that corresponds to a particular intensity of ambient light. The controller 20 may use nine millimeters as a baseline from which the relationship between the diameter of the pupil 16b and the ambient light detected by the pupil 16b is made. However, as each user's pupil 16b may have a different diameter than the other, the transmissivity of the window 18 may not be commensurate with the state of the user's eye. Accordingly, the user may input his user identification into the database 30.

The user may further actuate the input 28 so as to tune the baseline transmissivity established by the controller 20 to a desired transmissivity. The database 30 may be operable to store the tuning information selected by the user along with the state of the user's eye. Thus the user may adjust the baseline to either increase or decrease the transmissivity of the window 18. The information is stored in the database 30 and the controller 20 uses a user's preference so as to formulate a transmissivity profile 32 for that particular user and actuates the transmissivity of the windows 18 accordingly.

The system 10 may further include an actuator 34 in communication with the controller 20. The actuator 34 may be operable by a passenger to disable the controller 20 from adjusting the transmissivity of the window 18. This may be desirable when the passengers are wearing devices such as sunglasses. Alternatively, passengers may want to actuate the actuator 34 to maintain a selected transmissivity of the windows 18.

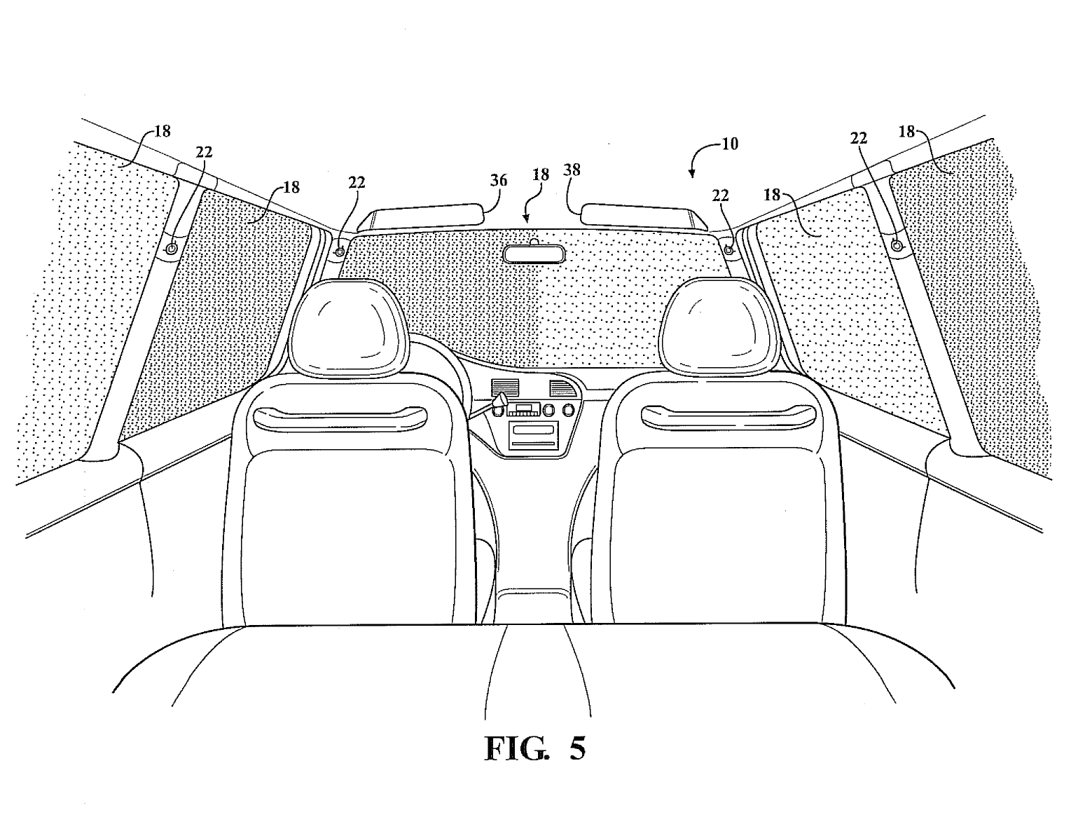

With reference now to FIG. 5, a second preferred embodiment of the system 10 is provided. In a second preferred embodiment the system 10 includes a plurality of windows 18 and a plurality of sensors 22. Each of the plurality of sensors 22 is operable to detect the diameter of a pupil 16b found in a predetermined area of the cabin space 12.

The controller 20 is operable to selectively adjust the transmissivity of the window 18 corresponding to the location of the pupil 16b. For instance, front passengers may have different light intensities based upon the position of the sun. Accordingly, it may be desirable for the front passengers to have the transmissivity of the window 18 reduced when the sun is facing them. However, passengers in the back may not be affected by the sun and thus the transmissivity of the window 18 may be greater, i.e., more light is allowed to pass through the rear windows 18 than the front window 18.

Alternatively, the window 18 may have predetermined regions 36, 38 wherein the sensors 22 are operable to adjust one of the predetermined regions 36, 38 based upon the position of the occupants in the cabin space 12. Accordingly, in cases where there are two front passengers, the system 10 may include a sensor 22 operable to detect the state of the pupil 16b of the left front passenger and a sensor 22 operable to detect the state of the pupil 16b of the right front passenger. The window 18 is generally divided into two regions 36, 38, a left region 36 and a right region 38. The transmissivity of the respective regions 36, 38 is based primarily upon the state of the pupil 16b of the respective left and right front passengers.

The system 10 further includes a pair of sensors 22 disposed on the B-pillar of the vehicle. The system 10 further includes a left rear passenger window 40 and a right rear passenger window 42. The left and right rear passenger windows 40, 42 are made of material operable to vary the transmissivity of the windows 18. One of the sensors 22 is disposed on the left B-pillar and the other sensor 22 is disposed on the right B-pillar.

The sensors 22 are positioned so as to detect respective left and right rear passengers. The sensors 22 disposed on the left and right B-pillars are both in communication with the controller 20. The controller 20 receives the state of the pupil 16b of the left and right rear passengers. The controller 20 is in communication with the left and right rear windows 18 and is operable to adjust the transmissivity of respective left and right rear windows 18 based upon the state of the pupil 16b of the corresponding left and right rear passengers.

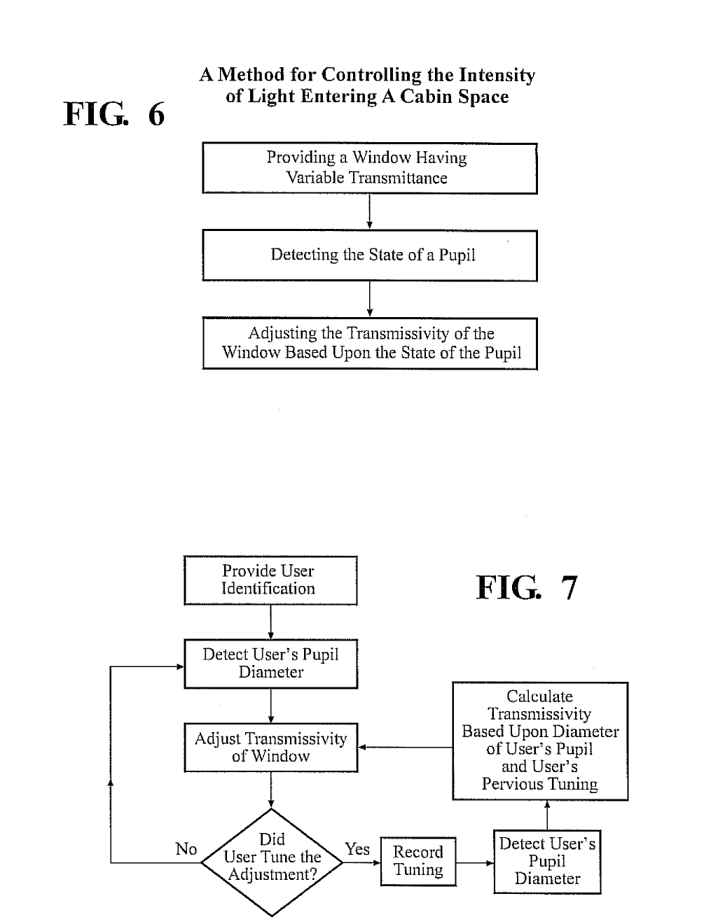

With reference now to FIG. 6, a method for controlling the intensity of light entering a cabin space 12 is provided. The method includes the step of providing a window 18 having variable transmittance and detecting the state of an iris 16a. The state of the iris 16a may be detected using a sensor 22 operable to detect the diameter of the pupil 16b.

The method proceeds to the step of adjusting the transmissivity of the window 18 based upon the state of the iris 16a. More specifically, the method may detect the diameter of the pupil 16b and adjust the transmissivity of the window 18 based upon the understanding that the diameter of a pupil 16b changes based upon the intensity of ambient light received.

The window 18 may be made of material such as liquid crystal cells 24 or electrochromic material 26. The method proceeds to adjusting the amount of electric current running through the window 18 so as to change the transmissivity of the window 18 to create a desired condition of ambient light within the cabin space 12.

With reference now to FIG. 7, the method may further include steps operable to adjust the transmissivity of the window based upon the user's preference. The method further includes the step of providing user identification. The diameter of the user's pupil 16b is detected and the transmissivity of the window 18 is automatically adjusted based upon the diameter of the pupil 16b. The method proceeds to the step of determining if the user tuned the automatic adjustment. For instance, did the user increase or decrease the transmissivity of the window 18. If there is no user tuning, then the method proceeds to adjusting the transmissivity based solely upon the diameter of the user's pupil 16b.

If the user tuned the automatic adjustment, the method proceeds to the step of recording the tuning. For instance, the method may include determining the amount of change in transmissivity made by the user, the current ambient lighting condition in the cabin space 12 established by the tuning, and the like. The method proceeds to detecting the state of the user's pupil and calculating a transmissivity based upon the diameter of the user's pupil and the user's previous tuning.

Obviously, many modifications and variations of the present invention are possible in light of the above teachings and may be practiced otherwise than as specifically described while within the scope of the appended claims.

I claim:

1. A system for controlling the intensity of light entering a cabin space, the system comprising:
a controller;
a window having variable transmittance, the window in communication with the controller; and
a sensor operable to detect the state of an iris, the sensor in communication with the controller, the controller processing the state of the iris so as to adjust the transmissivity of the window.

2. The system as set forth in claim 1, wherein the sensor is operable to detect the diameter of a pupil.

3. The system as set forth in claim 1, further including an actuator in communication with the controller, the actuator operable by the user to disable the controller from adjusting the transmissivity of the window.

4. The system as set forth in claim 1, wherein the window includes a plurality of liquid crystal cells operable to change the transmissivity of the window in response to an electric current.

5. The system as set forth in claim 1, wherein the window includes layer of electrochromic material operable to change the transmissivity of the window in response to an electric current.

6. The system as set forth in claim 1, further including an input and a database both in communication with the controller, the input actuated by one of a plurality of users and operable to transmit user information to the controller, the database storing sensor information, the controller processing user information and sensor information so as to calculate a transmissivity profile for each of the plurality of users, the transmissivity profile establishing a transmissivity of the window particular to the iris of the particular user.

7. The system as set forth in claim 6, wherein the input is further operable to adjust the transmissivity of the window.

8. The system as set forth in claim 1, wherein the window is a plurality of windows, and the sensor is a plurality of sensors, each of the plurality of sensors operable to detect the diameter of a pupil found in a predetermined area of the vehicle, the controller operable to selectively adjust the transmissivity of the window corresponding to the location of the pupil.

9. The system as set forth in claim 1, wherein the sensor includes a plurality of sensors, each of the plurality of sensors operable to detect the diameter of a pupil found in a predetermined area of the vehicle, the controller processing the sensor information so as to selectively adjust the transmissivity of predetermined regions of the window.

10. A method of controlling the intensity of light entering a cabin space, the method comprising the steps of:
providing a window having variable transmittance;
detecting the state of an iris;
adjusting the transmissivity of the window based upon the state of the iris.

11. The method as set forth in claim 10, wherein the state of the iris is the diameter a pupil.

12. The method as set forth in claim 11, wherein the window is made of liquid crystal cells.

13. The method as set forth in claim 11, further including the step of providing an input and a database, the input actuated by one of a plurality of users and operable to receive user information, the database storing sensor information, and processing user information and sensor information so as to calculate a transmissivity profile for each of the plurality of users, the transmissivity profile establishing a transmissivity of the window particular to the iris of the particular user.

14. The method as set forth in claim 11, further including the step of providing a plurality of sensors operable to detect the state of an iris found in a predetermined location and selectively adjusting predetermined regions of the window.
